(19) United States
(12) Patent Application Publication
(10) Pub. No.: US 2013/0216760 A1
(43) Pub. Date: Aug. 22, 2013

(54) METHOD FOR MANUFACTURING A NUMBER OF WALL COVERING ELEMENTS

(71) Applicant: Rientz Willem Bol, Hendrik-Ido-Ambacht (NL)

(72) Inventor: Rientz Willem Bol, Hendrik-Ido-Ambacht (NL)

(21) Appl. No.: 13/825,308

(22) PCT Filed: Sep. 21, 2011
(86) PCT No.: PCT/NL2011/050641

§ 371 Date: Apr. 22, 2013

(30) Foreign Application Priority Data
Sep. 21, 2010 (NL) 2005379

(51) Int. Cl. E04F 13/08; B63B 3/56; B29C 39/10

(52) U.S. Cl. CPC E04F 13/08; B29C 39/10; B63B 3/56
USPC 428/68; 264/241; 264/162; 114/116; 29/428

(57) ABSTRACT

The present invention relates to a method for manufacturing a number of wall-covering elements, comprising the steps of:—providing a core layer of a core layer material having an upper surface and a lower surface, with a number of first grooves in a pattern in the upper surface;—covering the upper surface of the core layer and filling the first grooves with a curing cover layer material in liquid form so that a cover layer with an upper surface is formed; and—arranging a number of second grooves in the upper surface of the cover layer along at least a part of the pattern of the filled first grooves, such that the surface of at least one of the walls of the second grooves is formed by the cover layer.

The present invention relates to a wall covering for a wall of a ship, such as a wall covering on the outer surface of the deck of a ship.

As wall covering on ships, and particularly as wall covering on the outer surface of the deck of a ship, use has traditionally been made of wooden planks in a strip pattern, particularly planks of teak, which has a high resistance to wood rot. A black flexible material is generally arranged here between adjacent planks, for instance in the form of a sealant, in order to compensate for the expansion of the wooden planks. Other wall parts of a ship, such as the outer surface of deck hatches, are usually also covered with wooden planks in such a strip pattern.

Wall coverings of plastic, such as PVC (Poly Vinyl Chloride), have been increasingly applied in the past decades as alternative to the teak wall covering. Although plastic wall coverings have some distinct advantages compared to teak wall coverings, such as simple manufacture and arranging of the wall covering, requiring little maintenance, wide availability and low cost, it has been found that shipowners and passengers particularly value the appearance of a teak wall covering.

The present invention relates particularly to a method for manufacturing a number of wall-covering elements, comprising the steps of:
providing a core layer of a core layer material having an upper surface and a lower surface, with a number of first grooves in a pattern in the upper surface;
covering the upper surface of the core layer and filling the first grooves with a curing cover layer material in liquid form so that a cover layer with an upper surface is formed; and
arranging a number of second grooves in the upper surface of the cover layer along at least a part of the pattern of the filled first grooves, such that the surface of at least one of the walls of the second grooves is formed by the cover layer.

This method according to the invention makes it possible in simple manner to manufacture a number of wall-covering elements with an upper surface and side surfaces which, through a suitable choice of the composition of the material of the cover layer, have the appearance of for instance a teak plank and which, depending on the chosen composition of the material of the core layer and the chosen dimensions of the core layer and the cover layer, can have additional properties which for instance correspond to the properties of a teak plank. It is thus possible for instance to manufacture a wall-covering element with an upper surface and side surfaces having not only the appearance of a teak plank, but also its thickness and rigidity. The method according to the invention makes it generally possible in simple manner to manufacture, in small series and at low cost, a number of wall-covering elements which are specifically adapted to a determined application, particularly a number of wall-covering elements wherein the core layer has a composition and/or dimensions which are specifically adapted to the function thereof, while the cover layer has a composition and/or dimensions which are specifically adapted to the function of the cover layer.

In the context of the invention a groove in an upper surface of an element is understood to mean a groove with a depth smaller than the distance between the upper surface and the lower surface of the element, as well as a groove with a depth equal to the distance between the upper surface and the lower surface of the element. In the latter case the groove cuts through the element. During filling of such a through-cutting groove a surface on which the element is arranged serves for instance as base.

In a favourable embodiment of the method according to the invention the providing of a core layer of a core layer material having an upper surface and a lower surface with a number of first grooves in a pattern in the upper surface comprises the step of arranging a number of separate core elements on a surface at a mutual distance forming the pattern of first grooves. This embodiment makes it possible to use preformed core elements to form the core layer, for instance extruded core elements.

In a favourable alternative embodiment of the method according to the invention, wherein the core layer is formed by means of separate core elements, the providing of a core layer with a core layer material having an upper surface and a lower surface with a number of first grooves in a pattern in the upper surface comprises the steps of:
providing a core layer with a flat upper surface, and
arranging the number of first grooves in the pattern in the flat upper surface of the core layer.

This embodiment makes it possible to provide the core layer in simple manner, and moreover enables particularly accurate arrangement of the second grooves relative to the first grooves. The latter is particularly the case when the first and second grooves are arranged by means of the same groove-forming machine without displacement of the core layer between the two groove-forming operations.

In a favourable embodiment hereof the providing of the core layer with a flat upper surface comprises the step of applying the core layer material in liquid form to a surface, wherein the core layer material is curing. This embodiment enables simple provision of the core layer, wherein it is also easily possible to arrange additional elements in the core layer, for instance connecting elements for connecting the wall-covering elements for manufacture to a wall, or for instance thermal elements for heating or cooling the wall-covering elements for manufacture.

In a further favourable embodiment, or additional embodiment, the core layer is arranged on a surface of a mould. This embodiment makes it possible to manufacture a number of wall-covering elements, wherein the lower surface of the core layer is not covered by the cover layer, or for instance a number of wall-covering elements, wherein the lower surface has a form defined by the form of the surface of the mould.

In an alternative embodiment hereof the method also comprises of providing an underlayer of the cover layer material with an upper surface, wherein providing of the core layer comprises of arranging the core layer on the upper surface of the underlayer. This measure makes it possible to manufacture a number of wall-covering elements wherein both the upper surface and the lower surface of the core layer are covered with the cover layer. This is for instance favourable when a number of wall-covering elements have to be manufactured in which a part of the upper surface and a part of the lower surface will be visible during use of the wall-covering elements.

In a further favourable embodiment of the method according to the invention the second grooves are arranged such that the surface of the two mutually facing walls of the second grooves are formed by the cover layer. This embodiment of the method makes it possible to manufacture two wall-covering elements simultaneously, wherein in both wall-covering elements at least a part of a side surface of the core layer is covered with the cover layer. This measure also makes it possible to manufacture a number of wall-covering elements with a number of grooves therein, wherein the two mutually opposite side walls of the grooves must be at least partially formed by the cover layer because these side walls will for instance be visible during use of the wall-covering elements. In a favourable embodiment hereof the width of the second grooves is smaller than the width of the first grooves.

In a further favourable embodiment of the method according to the invention the first grooves are arranged to a depth which is at least substantially the distance between the upper surface and the lower surface of the core layer. This embodiment makes it possible to manufacture a number of wall-covering elements wherein both the upper surface and a whole side surface of the core layer are covered by the cover layer.

In a further favourable embodiment of the method according to the invention the second grooves are arranged to a depth which is greater than the distance between the upper surface of the cover layer and the upper surface of the core layer. This embodiment of the method according to the invention makes it possible to manufacture a number of wall-covering elements wherein at least a part of a side surface of the core layer is covered with the cover layer. In a favourable embodiment hereof the second grooves are arranged to a depth which is smaller than the sum of the depth of the first grooves and the distance between the upper surface of the cover layer and the upper surface of the core layer. This measure makes it possible for the bottom of the second grooves to be formed by the cover layer.

In a further favourable embodiment of the method according to the invention the second grooves are arranged to a depth which is at least substantially the distance between the lower surface of the core layer and the upper surface of the cover layer. This embodiment of the method according to the invention makes it possible to manufacture a number of wall elements with a groove in the upper surface which is deeper than the thickness of the cover layer. This has the advantage that the core layer can be relatively thick compared to the cover layer.

In a further favourable embodiment of the method according to the invention at least a part of the pattern of the first grooves encloses a part of the upper surface of the core layer. This embodiment of the method according to the invention makes it possible to manufacture a number of wall elements wherein all the side surfaces of the core layer are at least partially covered with the cover layer. This makes possible for instance the manufacture of a plank-like wall-covering element wherein the sides as well as the end surfaces of the core layer are covered by means of the cover layer. This is advantageous when wall-covering elements have to be manufactured in a plank form where both a part of the sides and a part of the end surfaces will be visible when they are in use.

A further favourable embodiment of the method according to the invention comprises the step of machining a surface of the cover layer. This embodiment makes it possible for instance to arrange a pattern in a surface of the cover layer which is similar to for instance the surface of a teak plank. In a favourable embodiment hereof the step of machining a surface of the cover layer comprises of arranging third grooves in irregular manner in the surface of the cover layer to a depth which is smaller than the distance between the surface of the cover layer and the underlying surface of the core layer. Such machining results in a surface of the cover layer which is extremely similar to the surface of a teak plank. In a particularly favourable further embodiment hereof the method comprises of filling the third grooves with a filling material with a colour differing from that of the cover layer material. This embodiment of the method makes a surface of the cover layer possible which is highly similar to that of a teak plank.

In a favourable embodiment of the method according to the invention, wherein the surface of the cover layer is machined, the machining of the surface of the cover layer is carried out after the step of arranging the second grooves. This measure makes it possible to give two adjacent surfaces of the cover layer, which are separated by a groove, a different machining of the surface, and thereby a different appearance.

In a further favourable embodiment of the method according to the invention at least one of the core layer material and the cover layer material is a plastic material, preferably a plastic composite. This embodiment makes it possible in simple manner to adapt the properties of the cover layer and/or the core layer to the specific function thereof.

In a favourable embodiment of the method according to the invention the insulating value of the core layer material is higher than the insulating value of the cover layer material. This embodiment of the method according to the invention makes it possible for instance to manufacture a number of wall-covering elements with a cover layer which is not specifically composed to serve as insulation, but for instance to have the appearance of a teak plank, and a core layer which is specifically composed to serve as insulation. This is favourable when a number of wall-covering elements have to be manufactured which must have the appearance of for instance a teak plank and which must also be suitable for insulation.

In a further favourable embodiment of the method according to the invention, providing of the core layer comprises of providing a core layer with thermal elements at least partially received therein. This embodiment makes it possible for instance to manufacture a number of wall-covering elements having for instance the appearance of a teak plank, which can also provide for heating and/or cooling of the surface thereof. Because the thermal elements are arranged in a core layer of a core layer material and the core layer is covered with a cover layer of a cover layer material, it is for instance possible for the core layer to have a composition and/or dimensions specifically suitable for holding the thermal elements therein, for instance sufficient thickness and rigidity, while the cover layer has a composition and/or dimensions specifically suitable for the function thereof, for instance a specific appearance and/or elastic behaviour.

In a particularly favourable embodiment hereof the thermal elements comprise tubes for guiding a cooling liquid through the core layer. This enables a particularly simple manufacture of the wall-covering elements with thermal elements.

In a further favourable embodiment of the method according to the invention the providing of the core layer comprises of providing a core layer with mounting elements received at least partially therein for mounting the wall-covering elements on a wall. This embodiment of the method according to the invention enables the manufacture of a number of wall-covering elements which can be easily mounted on a wall.

In a further favourable embodiment of the method according to the invention the providing of the core layer comprises of providing a core layer with lighting elements received at least partially therein and supply elements co-acting with the lighting elements. This embodiment of the method according to the invention enables the manufacture of a number of wall-covering elements which can provide for lighting.

The present invention also relates to a wall-covering element comprising a core layer with an upper surface and a number of side surfaces, and a cover layer which covers the upper surface and at least one side surface of the core layer.

In a favourable embodiment of the wall-covering element according to the invention the insulating value of the core layer is higher than the insulating value of the cover layer.

In a further favourable embodiment of the wall-covering element according to the invention thermal elements are at least partially received in the core layer, wherein the thermal elements preferably comprise tubes for guiding a liquid through the core layer.

In a further favourable embodiment of the wall-covering element according to the invention lighting elements and supply elements co-acting with lighting elements are at least partially received in the core layer.

In a further favourable embodiment of the wall-covering element according to the invention mounting elements for mounting the wall-covering elements on a wall are at least partially received in the core layer.

The present invention also relates to a method for covering a surface of a wall, preferably a surface of a wall of a ship, more preferably a surface of a deck of a ship. This method according to the invention comprises the steps of:
providing a wall-covering element, comprising:
a core layer of a core layer material with an upper surface, a lower surface and a number of side surfaces; and
a cover layer of a cover layer material which covers the upper surface and at least one side surface of the core layer;
   and
arranging the wall-covering element on the surface of the wall for covering, wherein the upper surface of the core layer faces away from the surface of the wall for covering.

This method for covering a wall according to the invention makes it possible for instance to cover a deck of a ship with a material other than teak, while the appearance of the thus covered deck is similar to the appearance of a teak-covered deck.

In a favourable embodiment hereof the insulating value of the core layer material is higher than the insulating value of the cover layer material. This embodiment of the method for covering an outer surface of a wall enables a particularly simple insulation of the wall.

A further favourable embodiment of the method for covering a surface of a wall according to the invention comprises the steps of:
providing an additional wall-covering element, comprising:
a core layer of a core layer material with an upper surface, a lower surface and a number of side surfaces; and
a cover layer of a cover layer material which covers the upper surface and at least one side surface of the core layer;
   and
arranging the additional wall-covering element adjacently of the already arranged wall-covering element on the surface of the wall for covering, wherein the upper surface of the core layer of the additional wall-covering element faces away from the surface of the wall for covering, and wherein the colour of the cover layer material of the additional wall element differs from the colour of the cover layer material of the already arranged wall-covering element. This embodiment of the method for covering a wall makes possible an appearance of a wall covering which is extremely similar to a wall covering of teak planks.

The present invention also relates to a ship with a wall, preferably a deck wall, on which a number of wall-covering elements according to the invention are arranged.

The present invention will be further elucidated hereinbelow on the basis of a number of exemplary embodiments of the methods and the wall-covering element according to the invention shown schematically in the accompanying figures. These are non-limitative exemplary embodiments. In the figures:

FIGS. 1-9 show different views of a first embodiment of a method according to the invention;

FIGS. 10 and 11 show different views of a wall-covering element resulting from the method as shown in FIGS. 1-9;

FIGS. 12 and 13 show alternative embodiments of the wall-covering elements of FIGS. 10 and 11;

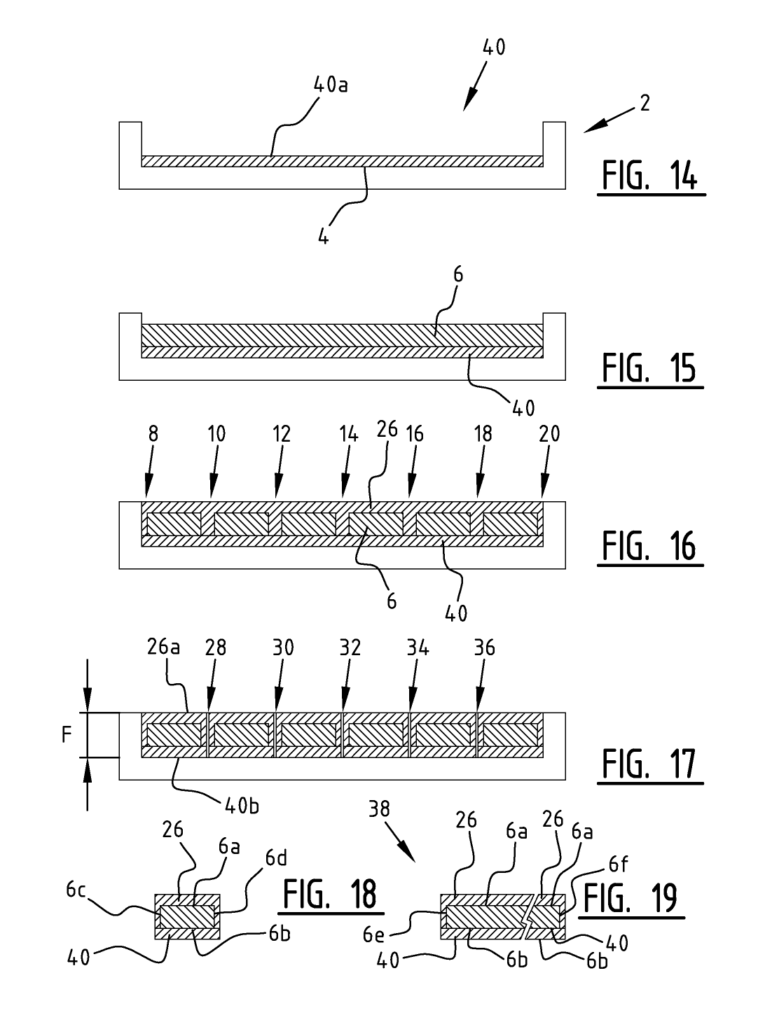

FIGS. 14-17 show different views of a second embodiment of a method according to the invention;

FIGS. 18 and 19 show different views of a wall-covering element resulting from the method as shown in FIGS. 14-17;

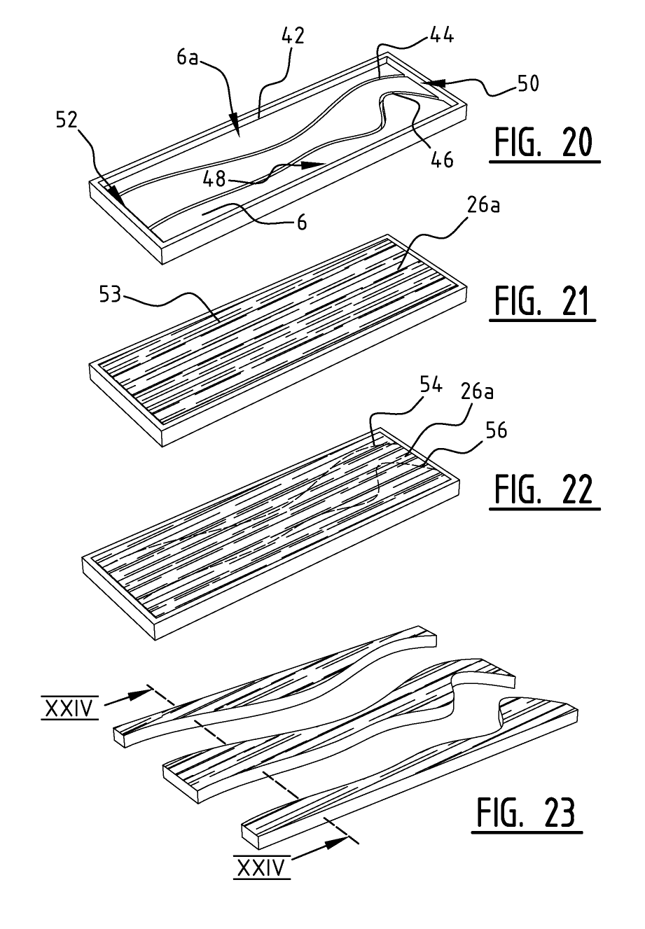

FIGS. 20-23 show different views of a third embodiment of a method according to the invention;

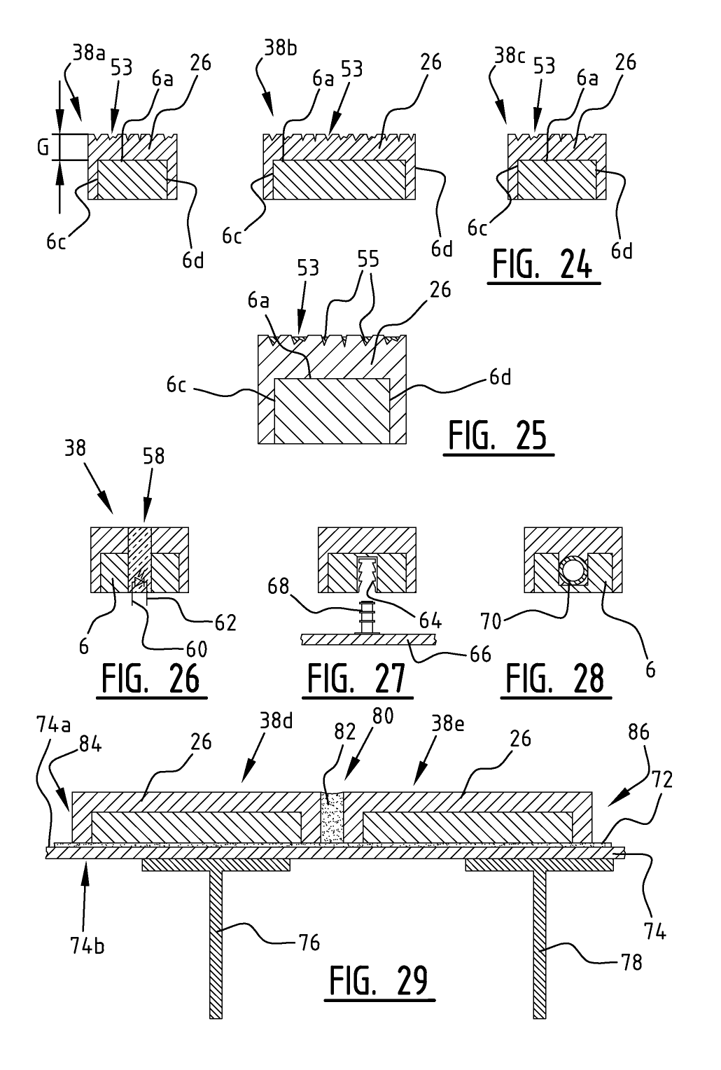

FIGS. 24 and 25 show cross-sections of a wall-covering element resulting from the method as shown in FIGS. 20-23;

FIGS. 26-28 show cross-sections of further embodiments of the wall-covering element according to the invention;

FIG. 29 shows a cross-section of a deck wall of a ship on which a number of wall-covering elements according to the invention are arranged;

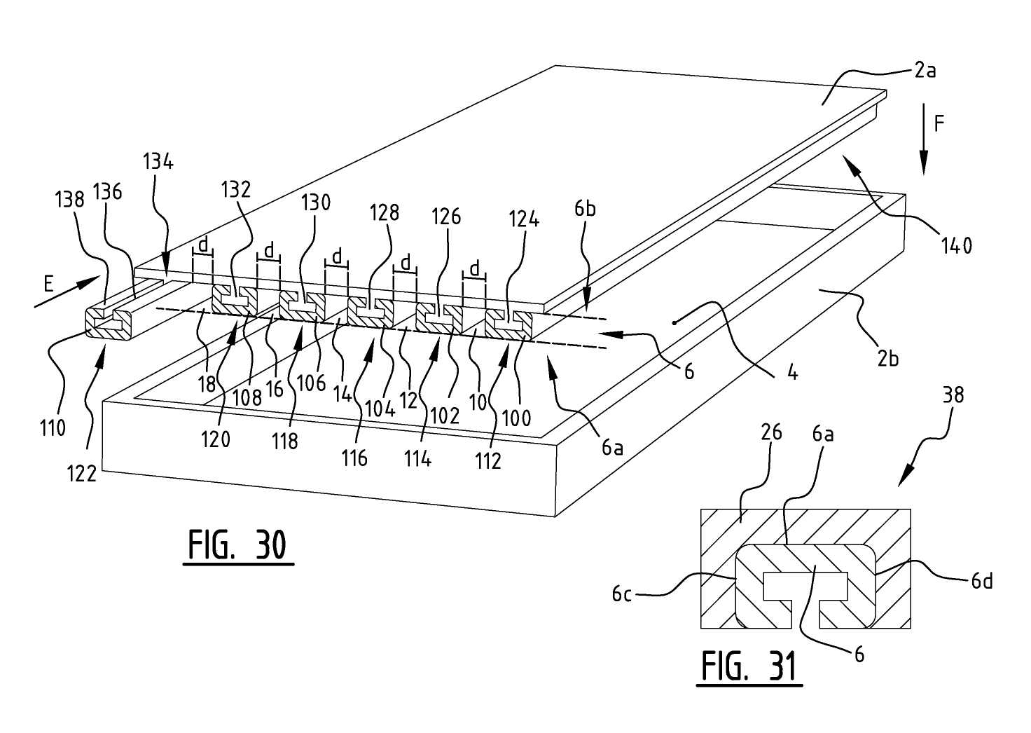

FIG. 30 shows a perspective view of a step in a third embodiment of a method according to the invention;

FIG. 31 shows a wall-covering element manufactured according to the method, a step of which is shown in FIG. 30.

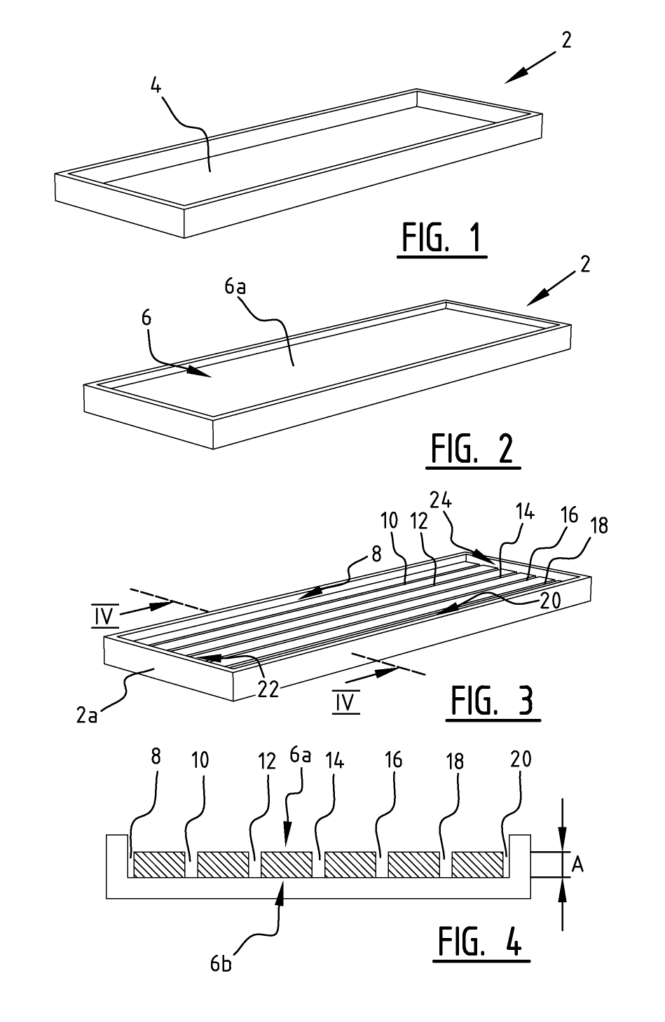

FIG. 1 shows a mould 2 for manufacturing a number of wall-covering elements by means of performing the method according to the invention. In an embodiment of the method according to the invention a core layer is arranged on surface 4 of mould 2, for instance by arranging a curing core layer material in liquid form on surface 4 of mould 2 so that, as shown in FIG. 2, after curing of the core layer material a core layer 6 with an upper surface 6a and a lower surface 6b (not visible) facing toward surface 4 of mould 2 is provided on surface 4 of mould 2.

By arranging in a subsequent step a number of first grooves 8 to 24 in a strip pattern in upper surface 6a of core layer 6 the situation is brought about as shown in FIG. 3. FIG. 4 shows in cross-section that first grooves 8 to 24 are arranged to a depth which is equal to the distance A between upper surface 6a and lower surface 6b of core layer 6. The same applies for the first grooves 22 and 24 (not shown in the figure) which are arranged in the upper surface of core layer 6 close to the ends of mould 2a and 2b in a direction perpendicularly of the first grooves 8-20.

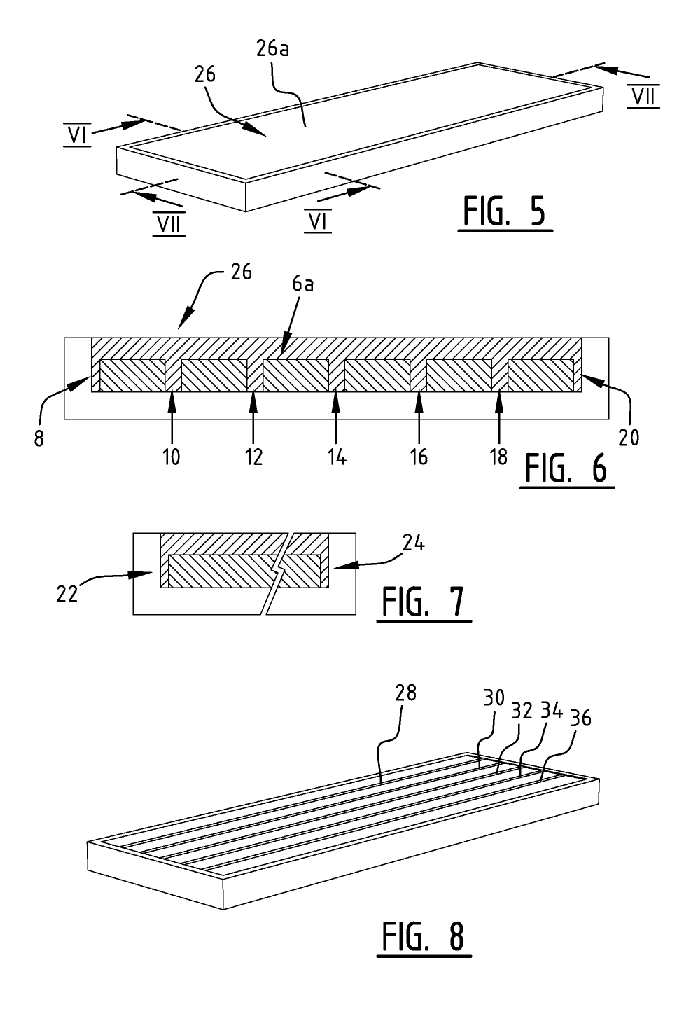

By then arranging a curing cover layer material in liquid form on upper surface 6a of core layer 6, a cover layer 26 is formed with an upper surface 26a as shown in FIG. 5. FIGS. 6 and 7 show that the cover layer material of cover layer 26 not only covers upper surface 6a of the core layer, but also fills first grooves 8 to 24.

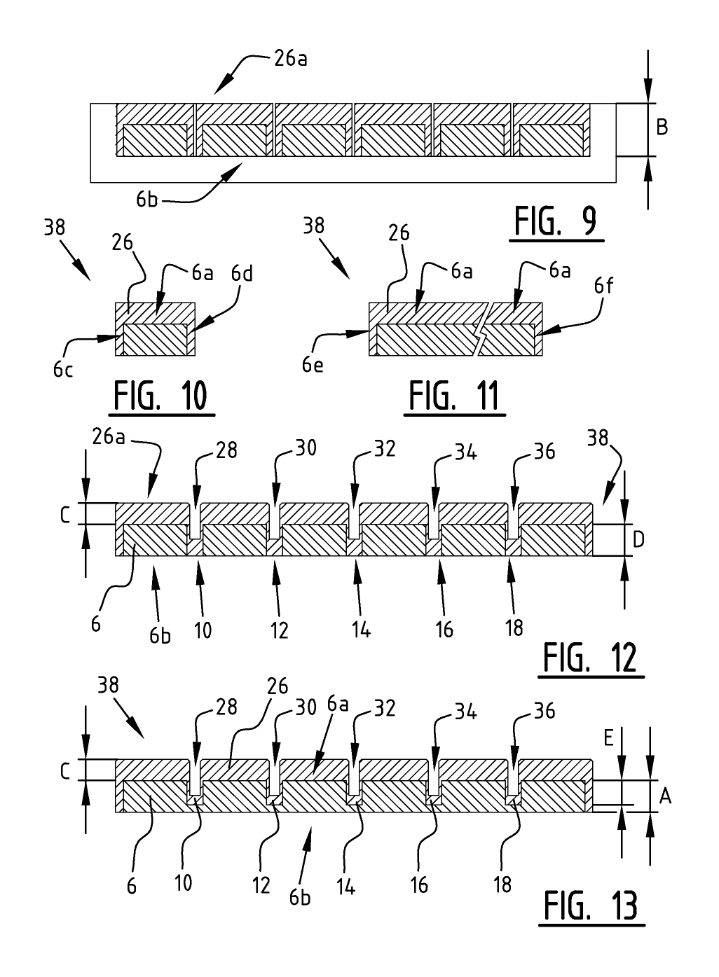

From the situation as shown in FIG. 5, subsequently arranging a number of second grooves 28 to 36 in upper surface 26a of the cover layer along at least a part of the pattern of the filled first grooves 8 to 24 brings about the situation as shown in FIG. 8. As shown in cross-section in FIG. 9, second grooves 28 to 36 are arranged to a depth equal to the distance B between lower surface 6b of the core layer and upper surface 26a of cover layer 26. Six elongate wall-covering elements 38 are thus manufactured which, as shown in cross-section in FIG. 10 and in longitudinal section in FIG. 11, comprise a core layer 6 with an upper surface 6a and side surfaces 6c to 6f and a cover layer 26 covering side surfaces 6c to 6f. That all the side surfaces of the core layer of wall-covering element 38 are covered by the cover layer is the result of a part of the pattern of the first grooves enclosing a part of the upper surface of the core layer.

FIG. 12 shows the result of an alternative embodiment of the method as shown in FIGS. 1-9. FIG. 12 shows a single wall-covering element 38 which is realized not as shown in FIG. 9 by arranging second grooves 28 to 36 to a depth B equal to the distance between lower surface 6b of core layer 6 and upper surface 26a of cover layer 26, but by arranging second grooves 28 to 36 to a depth which is greater than the distance C between the upper surface of cover layer 26a and smaller than the sum of the distance C and the depth D of first grooves 10 to 18. The resulting wall-covering element 38 has a number of grooves 28 to 36 in the upper surface thereof, wherein the bottom of grooves 28 to 36 and the two mutually opposite walls thereof are formed by cover layer 26, while apart of the side surfaces of core layer 6 is also covered with cover layer 26.

FIG. 13 shows the result of a further alternative embodiment of the method as shown in FIGS. 1-9. The wall-covering element 38 shown in FIG. 13 is manufactured not as shown in FIGS. 3 and 4 by arranging first grooves 10 to 18 to a depth equal to the distance A between upper surface 6a of cover layer 6 and lower surface 6b of core layer 6, but to a depth E which is smaller than the distance A. As shown in FIGS. 5 and 6, a cover layer 26 is then arranged on upper surface 6a of core layer 6, and second grooves are arranged in upper surface 26a of cover layer 26. Second grooves 28 to 36 are arranged to a depth which is greater than the distance C between the upper surface of cover layer 26a and smaller than the sum of the distance C and the depth E of first grooves 10 to 18. As in the case of wall-covering element 38 of FIG. 12, a number of grooves 28 to 36 are arranged in the upper surface of wall-covering element 38 of FIG. 13, wherein both the bottom of the grooves and the two mutually opposite walls thereof are formed by cover layer 26.

FIGS. 14-17 show a further alternative embodiment of the method as shown in FIGS. 1-9. FIG. 14 shows that an underlayer 40 of the cover layer material is arranged on surface 4 of mould 2, this underlayer 40 having an upper surface 40a. This underlayer 40 can be arranged by applying the curing cover layer material in liquid form to surface 4 of mould 2 and allowing it to cure. The situation as shown in FIG. 15 is realized by then arranging core layer 6 of the cover layer material on upper surface 40a. The situation as shown in FIG. 16 is brought about by arranging, in a subsequent number of steps as shown in FIGS. 3-6, a first number of grooves 8 to 24 in the upper surface of core layer 6 and covering the upper surface of core layer 6 with a cover layer 26 of the cover layer material, wherein first grooves 8 to 24 are also filled with the cover layer material. The situation as shown in FIG. 17 is brought about by arranging, in a subsequent step as shown in FIGS. 8 and 9, second grooves 28 to 36 in upper surface 26a of cover layer 26 to a depth equal to the distance F between upper surface 26a of cover layer 26 and lower surface 40b of underlayer 40. Six elongate wall-covering elements 38 are thus manufactured, wherein, as shown in cross-section in FIG. 18 and in longitudinal section in FIG. 19, not only are upper surface 6a and side surfaces 6c to 6f covered, but also lower surface 6b of core layer 6.

FIGS. 20-23 show a further alternative embodiment of the method according to the invention as shown in FIGS. 1-9. FIG. 20 shows that, instead of first grooves 8 to 24 arranged in a strip pattern, first grooves 42 to 52 are arranged in another pattern in upper surface 6a of core layer 6. The situation as shown in FIG. 21 is brought about by arranging, as shown in FIGS. 5-7, a cover layer 26 of the cover layer material on upper surface 6a, wherein first grooves 42 to 52 are also filled with the cover layer material of cover layer 26, and subsequently machining upper surface 26a by arranging third grooves 53 in irregular manner in upper surface 26a of cover layer 26 to a depth which is smaller than the distance between upper surface 26a of cover layer 26 and the underlying upper surface 6a of core layer 6.

FIG. 22 shows that second grooves 54 and 56 are then arranged in upper surface 26a of cover layer 26 along a part of the pattern of the filled first grooves 42 to 52, in particular along the filled first grooves 44 and 46, so that as shown in FIG. 23 three wall-covering elements 38a, 38b and 38c are manufactured. Because the second grooves 54 and 56 are arranged such that the surface of the two mutually facing walls of the second grooves is formed by cover layer 26, each of the wall-covering elements 38a, 38b, 38c has a core layer 6 as shown in cross-sections in FIG. 24, wherein both upper surface 6a of core layer 6 and side surfaces 6c and 6d are covered by cover layer 26. FIG. 24 also shows that third grooves 53 are arranged in upper surface 26a to a depth which is smaller than the distance G between the upper surface of cover layer 26 and the underlying upper surface 6a of core layer 6. FIG. 25 shows that the third grooves 53 are at least partially filled with a filling material which has a colour differing from that of the cover layer material of cover layer 26, so that the third grooves are accentuated.

FIG. 26 shows an alternative embodiment of wall-covering elements 38 as shown in the foregoing figures. In the wall-covering element 38 of FIG. 25 a lighting element in the form of a LED element 58 and, co-acting therewith, supply elements in the form of power cables 60 and 62 are partially received in core layer 6. Starting from the situation as shown in FIG. 2, the lighting element in the form of LED element 58 and supply elements in the form of power cables 60 and 62 co-acting therewith can be arranged in wall-covering element 38 by pressing the lighting element in the form of LED element 58 and supply elements in the form of power cables 60 and 62 co-acting therewith at least partially into the core layer material, this after arranging of the curing core layer material in liquid form on surface 4 of mould 2 and before curing of the core layer material, so that LED element 58 protrudes further above upper surface 6a of core layer 6 than the desired thickness of cover layer above upper surface 6a of core layer 6. After cover layer 26 has been arranged, the portion of LED element 58 protruding above upper surface 26a of cover layer 26 can then be levelled until upper surface 26a of cover layer 26 and the upper surface of the LED element form an uninterrupted surface.

In an alternative embodiment hereof as shown in FIG. 27 a mounting element in the form of a mounting bush 64 is at least partially received in the core layer of wall-covering element 38. This connecting bush 64 can co-act with a connecting member 68 arranged on wall 66 for optionally releasable mounting of wall-covering element 38 on wall 66. Starting from the situation as shown in FIG. 1 and before applying the curing core layer material in liquid form to surface 4 of mould 2, mounting bush 64 can be arranged by placing connecting bush 64 on surface 4 of mould 2.

FIG. 28 shows a further alternative embodiment of wall-covering element 38 of FIG. 25. In this embodiment a thermal element in the form of a tube 70 for guiding a cooling liquid through core layer 6 is at least partially received in core layer 6. Starting from the situation as shown in FIG. 3 and before covering upper surface 6a of core layer 6, tube 70 can be arranged by making additional grooves in the core layer and laying tube 70 in these additional grooves. It is alternatively possible, starting from the situation as shown in FIG. 2 after applying of the curing core layer material in liquid form to surface 4 of mould 2 and before curing of the core layer material, to press tube 70 into the core layer material or, starting from the situation as shown in FIG. 1, to place tube 70 on surface 4 of mould 2 before applying the curing core layer material in liquid form to surface 4 of mould 2.

In FIG. 29 two wall elements 38d and 38e as shown in FIG. 10 are arranged by means of an adhesive layer 72 on an outer surface 74a of a wall 74. Wall 74 is in particular a deck wall of a ship which is reinforced on the inner side 74b thereof by means of profile beams 76 and 78. A sealant layer 82 is arranged in the space 80 between wall-covering elements 38. Because the core layer material of core layer 6 has a higher insulating value than the cover layer material of cover layer 26, wall-covering elements 38d and 38e can insulate deck wall 74 without insulating material having to be arranged on inner side 74b of the deck wall, while the appearance of wall-covering elements 38d and 38e is similar to the appearance of a teak wall covering. Contributing toward this similarity is the fact that side surfaces 84 and 86 of wall-covering elements 38d and 38e are formed by cover layer 26 and that the colour of the material of cover layer 26 of wall-covering element 38d differs from the colour of the material of cover layer 26 of wall-covering element 38e. Arranging insulation on the outer surface of wall 74 also avoids profile beams 76 and 78 forming a cold bridge.

Shown in the figures and described in the figure description is that the core layer is formed by applying a curing core layer material in liquid form to a surface. It is however also possible to arrange a core layer in the form of a solid core element on the surface in order to provide the core layer. It is possible here for the first grooves to be already arranged in the solid core element. It is also possible for separate core elements to be arranged on the surface at a mutual distance forming a pattern of first grooves so that for instance the situation as shown in FIGS. 3, 4 and 20 is realized in one operation. The individual upper surfaces of the separate core elements together then form the upper surface of the core layer in which first grooves are arranged in a pattern.

FIG. 30 shows an advantageous method of realizing a core layer 6 of a core layer material with an upper surface 6a and a lower surface 6b, with a number of first grooves 10, 12, 14, 16, 18 in a pattern in upper surface 6a. A number of separate core elements 100, 102, 104, 106, 108, 110 with an upper surface 112, 114, 116, 118, 120, 122 facing downward (in the direction of arrow F) are pushed here onto a number of protrusions 124, 126, 128, 130, 132, 134 of mould part 2a. Core elements 100, 102, 104, 106, 108, 110 are provided for this purpose with a recess 136 in the lower surface 138 thereof, which takes a form such that it can be brought into engagement with protrusions 124, 126, 128, 130, 132, 134 of mould part 2a. In the shown exemplary embodiment the protrusions are T-shaped in cross-section of mould part 2a and recesses 136 have a complementary shape, particularly an inverted T-shape, in cross-section of core elements 100, 102, 104, 106, 108, 110. Core elements 100, 102, 104, 106, 108, 110 have dimensions and protrusions 124, 126, 128, 130, 132, 134 have a location such that, once the final core element 110 has been pushed over protrusion 134 in the direction of arrow E, core elements 100, 102, 104, 106, 108, 110 are arranged at a mutual distance d forming a pattern of first grooves 10, 12, 14, 16, 18 on surface 140 of mould part 2a. The individual upper surfaces 112, 114, 116, 118, 120, 122 of the separate core elements 100, 102, 104, 106, 108, 110 together then form the upper surface 6a of core layer 6, in which first grooves 10, 12, 14, 16, 18 are arranged in a pattern. By subsequently filling mould part 2b with a curing cover layer material in liquid form and moving the core elements in the direction of arrow F into the liquid cover layer material, the upper surface 6a of core layer 6 is covered and first grooves 10, 12, 14, 16, 18 are filled with the curing cover layer material in liquid form. As the cover layer material cures, a cover layer with an upper surface is then formed, wherein the upper surface of the cover layer is in contact with bottom surface 4 of mould part 2b. By then taking the assembly of cover layer and core elements 100, 102, 104, 106, 108, 110 out of mould part 2b and arranging a number of second grooves in the upper surface of the cover layer along at least a part of the pattern of the filled first grooves 10, 12, 14, 16, 18, for instance by means of a sawing machine, a number of wall-covering elements 38 can be realized as shown in cross-section in FIG. 31. Wall-covering element 38 shown in FIG. 31 has a core layer 6 with an upper surface 6a and two side surfaces 6c, 6d, and a cover layer 26 which covers the upper surface and the side surfaces of the core layer. A wall-covering element similar to wall-covering element 38 as shown in FIG. 12 can however also be realized according to the shown method.

In the method according to the invention the upper surface of the core layer can thus be covered and the first grooves in the upper surface of the core layer can be filled, either by pouring cover layer material in liquid form onto the upper surface of the core layer and into the first grooves or by immersing the upper surface of the core layer and the first grooves arranged therein into cover layer material in liquid form.

The recesses and protrusions shown in FIG. 30 are position-determining elements with which the position of the core elements relative to each other in mould parts 2a, 2b can be determined. Such position-determining elements can also take a different form and can be arranged on the core elements and/or the mould parts. The protrusions of T-shaped cross-section as shown in FIG. 30 can also be arranged on the bottom surface of mould 2 of FIG. 1. It must then be possible however to open mould 2 on a side thereof to enable sliding of the core elements as shown in FIG. 30 over the protrusions. It is also possible to hold separate core elements at the position thereof by means of a vacuum system, wherein a vacuum is applied between the individual core elements and the surface on which they are arranged. During pouring of the core layer, as for instance described with reference to FIG. 1, it is for instance possible to arrange pointed position-determining elements on surface 4 of mould 2 if it is desired to hold in their position the individual core elements realized during forming of the first grooves.

FIGS. 21-25 show that the upper surface of the cover layer is machined. It is also possible for side surfaces of the wall-covering elements to be machined, for instance by arranging third grooves in an irregular pattern and optionally at least partially filling these third grooves with a filling material having a colour differing from the colour of the cover layer. A machining of a surface of the cover layer is also possible in the embodiments of the method according to the invention as shown in FIGS. 1-19.

FIGS. 21-25 show that the lower surface of the core layer is not covered with a layer of the cover layer material. This lower surface of the core layer could also be covered with the cover material.

The core layer as shown in the figures can also be made up of a number of sub-layers.

In FIGS. 26-28 different elements are arranged at least partially in the core layer. It is also possible for the elements to be arranged in other embodiments of the wall element according to the invention, such as the embodiments shown in FIGS. 12 and 13. It is also possible for different elements to be arranged in combination in a core layer.

The cover layer and core layer of the embodiments of the method and the wall-covering element as shown in the figures are preferably of a plastic material, in particular a plastic composite. The filling material for filling the third grooves is preferably also a plastic material, in particular a plastic composite.

Using the wall-covering elements according to the invention it is otherwise also possible to form a wall instead of covering it. The core layer can for instance be composed and have dimensions here such that the wall-covering element is rigid enough to form the wall.

It is also possible to combine measures of the different embodiments of the methods and wall-covering elements as shown in the different figures. The dependencies in the dependent claims state possible combinations of measures.

1. A method for manufacturing a wall covering, or an element therefor, comprising the steps of:
providing a core layer of a core layer material having an upper surface and a lower surface, with a number of first grooves in a pattern in the upper surface;
covering the upper surface of the core layer and filling the first grooves with a curing cover layer material in liquid form so that a cover layer with an upper surface is formed; and
arranging a number of second grooves in the upper surface of the cover layer along at least a part of the pattern of the filled first grooves, such that the surface of at least one of the walls of the second grooves is formed by the cover layer.

2. The method as claimed in claim 1, wherein the providing of a core layer of a core layer material having an upper surface and a lower surface with a number of first grooves in a pattern in the upper surface comprises the step of:
arranging a number of separate core elements on a surface at a mutual distance forming the pattern of first grooves.

3. The method as claimed in claim 1, wherein the providing of a core layer with a core layer material having an upper surface and a lower surface with a number of first grooves in a pattern in the upper surface comprises the steps of:
providing a core layer with a flat upper surface, and
arranging the number of first grooves in the pattern in the flat upper surface of the core layer.

4. The method as claimed in claim 3, wherein the providing of the core layer with a flat upper surface comprises the step of applying the core layer material in liquid form to a surface, wherein the core layer material is curing.

5. The method as claimed in claim 1, wherein the core layer is arranged on a surface of a mould.

6. The method as claimed in claim 1, wherein the method also comprises of providing an underlayer of the cover layer material with an upper surface, and wherein providing of the core layer comprises of arranging the core layer on the upper surface of the underlayer.

7. The method as claimed in claim 1, wherein the second grooves are arranged such that the surface of the two mutually facing walls of the second grooves are formed by the cover layer, wherein the width of the second grooves is preferably smaller than the width of the first grooves.

8. The method as claimed in claim 1, wherein the first grooves are arranged to a depth which is at least substantially the distance between the upper surface and the lower surface of the core layer.

9. The method as claimed in claim 1, wherein the second grooves are arranged to a depth which is greater than the distance between the upper surface of the cover layer and the upper surface of the core layer, and preferably to a depth which is smaller than the sum of the depth of the first grooves and the distance between the upper surface of the cover layer and the upper surface of the core layer.

10. The method as claimed in claim 1, wherein the second grooves are arranged to a depth which is at least substantially the distance between the lower surface of the core layer and the upper surface of the cover layer.

11. The method as claimed in claim 1, wherein at least a part of the pattern of first grooves encloses a part of the upper surface of the core layer.

12. The method as claimed in claim 1, also comprising the step of machining a surface of the cover layer, preferably comprising of arranging third grooves in irregular manner in the surface of the cover layer to a depth which is smaller than the distance between the surface of the cover layer and the underlying surface of the core layer, more preferably comprising of filling the third grooves with a filling material with a colour differing from the colour of the cover layer material.

13. The method as claimed in claim 12, wherein the step of machining a surface of the cover layer is performed after the step of arranging the second grooves.

14. The method as claimed in claim 1, wherein at least one of the core layer material and the cover layer material is a plastic material, preferably a plastic composite.

15. The method as claimed in claim 1, wherein the insulating value of the core layer material is higher than the insulating value of the cover layer material.

16. The method as claimed in claim 1, wherein the providing of the core layer comprises of providing a core layer with thermal elements at least partially received therein, wherein the thermal elements preferably comprise tubes for guiding a cooling liquid through the core layer.

17. The method as claimed in claim 1, wherein the providing of the core layer comprises of providing a core layer with mounting elements received at least partially therein for mounting the wall-covering elements on a wall.

18. The method as claimed in claim 1, wherein the providing of the core layer comprises of providing a core layer with lighting elements received at least partially therein and supply elements co-acting with the lighting elements.

19. A wall-covering element, comprising:
a core layer with an upper surface and a number of side surfaces, and
a cover layer which covers the upper surface and at least one side surface of the core layer.

20. The wall-covering element as claimed in claim 19, wherein the insulating value of the core layer is higher than the insulating value of the cover layer.

21. The wall-covering element as claimed in claim 19, wherein thermal elements are at least partially received in the core layer.

22. The wall-covering element as claimed in claim 19, wherein lighting elements and supply elements co-acting with lighting elements are at least partially received in the core layer.

23. The wall-covering element as claimed in claim 19, wherein mounting elements for mounting the wall-covering elements on a wall are at least partially received in the core layer.

24. A method for covering a surface of a wall, comprising the steps of:
providing a wall-covering element, comprising:
a core layer of a core layer material with an upper surface, a lower surface and a number of side surfaces; and
a cover layer of a cover layer material which covers the upper surface and at least one side surface of the core layer; and
arranging the wall-covering element on the surface of the wall for covering, wherein the upper surface of the core layer faces away from the surface of the wall for covering.

25. The method as claimed in claim 24, wherein the insulating value of the core layer material is higher than the insulating value of the cover layer material.

26. A method as claimed in claim 24, also comprising the steps of:
providing an additional wall-covering element, comprising:
a core layer of a core layer material with an upper surface, a lower surface and a number of side surfaces;
a cover layer of a cover layer material which covers the upper surface and at least one side surface of the core layer; and
arranging the additional wall-covering element adjacently of the already arranged wall-covering element on the surface of the wall for covering, wherein the upper surface of the core layer of the additional wall-covering element faces away from the surface of the wall for covering, and wherein the color of the cover layer material of the additional wall element differs from the color of the cover layer material of the already arranged wall-covering element.

27. A ship with a wall on which a number of wall-covering elements as claimed in claim 19 are arranged.
